(19) United States
(12) Patent Application Publication
(10) Pub. No.: US 2024/0069953 A1
(43) Pub. Date: Feb. 29, 2024

(54) TIMER PROCESSING METHOD, APPARATUS, ELECTRONIC DEVICE, AND COMPUTER-READABLE STORAGE MEDIUM

(71) Applicant: Beijing Bytedance Network Technology Co., Ltd., Beijing (CN)

(72) Inventors: Yang ZHANG, Beijing (CN); Yibo ZHOU, Beijing (CN)

(21) Appl. No.: 18/261,473

(22) PCT Filed: Feb. 21, 2022
(86) PCT No.: PCT/CN2022/077037

§ 371 Date: Jul. 13, 2023

(30) Foreign Application Priority Data
Feb. 25, 2021 (CN) 202110210738.0

(51) Int. Cl. G06F 9/455

(52) U.S. Cl. CPC G06F 9/45558; G06F 2009/45575

(57) ABSTRACT

This disclosure discloses a timer processing method, an apparatus, an electronic device, and a computer-readable storage medium. The timer processing method includes: determining a type of a timer used by a physical machine before a virtual machine starts, wherein the virtual machine runs on the physical machine; determining a first time and a first deadline of the virtual machine which are before the virtual machine starts; in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and configuring the adjusted first-type timer as a timer of the virtual machine.

### CROSS-REFERENCE TO RELATED APPLICATIONS

The present disclosure is based on and claims priority of Chinese application for invention No. 202110210738.0, filed on Feb. 25, 2021, the disclosure of which is hereby incorporated into this disclosure by reference in its entirety.

### TECHNICAL FIELD

Embodiments of the present disclosure relate to the field of computer technology, and in particular, to a timer processing method, an apparatus, an electronic device, and a computer-readable storage medium.

### BACKGROUND

Currently, kernel-based virtual machine (KVM) platforms implement timers for virtual machines through software simulation. Each time a deadline is set for a timer, a virtual machine exits to a physical machine if the virtual machine uses a local APIC timer and runs in TSC deadline mode.

### SUMMARY

This summary is provided for a concise introduction of the inventive concept of the present application, which will be described in detail in the Detailed Description below. This summary is not intended to identify critical features or essential features of the claimed technical solution, nor is it intended to be used to limit the scope of the claimed technical solution.

In a first aspect, an embodiment of the present disclosure provides a timer processing method, comprising: determining a type of a timer used by a physical machine before a virtual machine starts, wherein the virtual machine runs on the physical machine; determining a first time and a first deadline of the virtual machine which are before the virtual machine starts; in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and configuring the adjusted first-type timer as a timer of the virtual machine.

In a second aspect, some embodiments of the present disclosure provide a timer processing apparatus, comprising: a first determination unit for determining a type of a timer used by a physical machine before a virtual machine starts, wherein the virtual machine runs on the physical machine; a second determination unit for determining a first time and a first deadline of the virtual machine which are before the virtual machine starts; an adjustment unit for, in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and a configuration unit for configuring the adjusted first-type timer as a timer of the virtual machine.

In a third aspect, some embodiments of the present disclosure provide an electronic device, comprising: one or more processors; a memory device having stored thereon one or more programs that, when executed by the one or more processors, cause the one or more processors to implement the method described in the first aspect.

In a fourth aspect, some embodiments of the present disclosure provide a non-transitory computer-readable medium having stored thereon a computer program that, when executed by a processor, implements the method described in the first aspect.

In a fifth aspect, an embodiment of the present disclosure provides a computer program, comprising: instructions that, when executed by a processor, cause the processor to execute the method described in the first aspect.

In a sixth aspect, an embodiment of the present disclosure provides a computer program product comprising instructions that, when executed by a processor, cause the processor to perform the method described in the first aspect.

### BRIEF DESCRIPTION OF THE DRAWINGS

The above and other features, advantages, and aspects of the embodiments of the present disclosure will become more apparent from the following embodiments with reference to the drawings. Throughout the drawings, the same or similar reference signs indicate the same or similar elements. It should be understood that the drawings are schematic and the components and elements are not necessarily drawn to scale.

FIG. 1 is a schematic diagram showing an application scenario of a timer processing method according to some embodiments of the present disclosure;

FIG. 2 is a flowchart of the timer processing method according to some embodiments of the present disclosure;

FIG. 3 is a schematic diagram showing a virtual machine triggering an interrupt in the timer processing method according to some embodiments of the present disclosure;

FIG. 4 is a flowchart of the timer processing method according to other embodiments of the present disclosure;

FIG. 5 is a schematic diagram showing a physical machine triggering an interrupt in the timer processing method according to some embodiments of the present disclosure;

FIG. 6 is a schematic structural diagram of a timer processing apparatus according to some embodiments of the present disclosure;

FIG. 7 is a schematic structural diagram of an electronic device suitable for implementing some embodiments of the present disclosure.

### DETAILED DESCRIPTION

Exemplary embodiments of the present disclosure will now be described in detail with reference to the accompanying drawings. Although some exemplary embodiments of the present disclosure are shown in the drawings, it should be understood that the present disclosure can be implemented in various forms and should not be construed as limited to the embodiments set forth herein. Rather, these embodiments are provided for a thorough and complete understanding of the present disclosure. It should be understood that the drawings and embodiments of the present disclosure are only used for exemplary purposes, and are not used to limit the scope of protection of the present disclosure.

In addition, it should be noted that, for the convenience of description, only the parts related to the invention are shown in the drawings. In the case of no conflict, the embodiments and the features of the embodiments of the present disclosure may be combined with each other.

It should be noted that the concepts of “first” and “second” mentioned in the present disclosure are only used to distinguish different devices, modules or units, and are not used to limit the order of functions performed by these devices, modules or units, or interdependence therebetween.

It should be noted that the modifications of “a” and “a plurality of” mentioned in the present disclosure are illustrative and not restrictive, and those skilled in the art should understand that unless clearly indicated in the context, they should be understood as “one or more”.

The names of messages or information exchanged between multiple devices in the embodiments of the present disclosure are only used for illustrative purposes, and are not used to limit the scope of these messages or information.

If a virtual machine uses a local APIC timer and runs in TSC-Deadline mode, every time a deadline is set for the timer, the virtual machine exits to the physical machine. In some business scenarios, frequent virtual machine exits have a significant impact on virtual machine performance. Some embodiments of the present disclosure provide a timer processing method, an apparatus, a device, and a computer-readable storage medium to solve the above technical problem.

Hereinafter, the present application will be described in detail with reference to the drawings and in conjunction with embodiments.

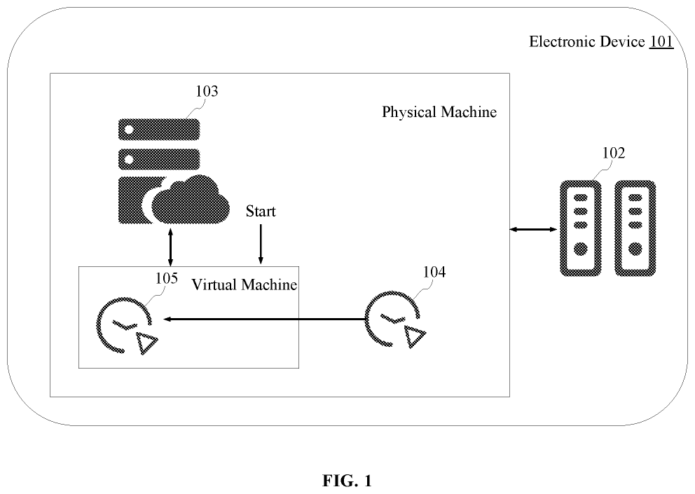

FIG. 1 is a schematic diagram showing an application scenario of a timer processing method according to some embodiments of the present disclosure.

As shown in FIG. 1, first of all, an electronic device 101 determines a type of timer used by a physical machine 102 before a virtual machine 103 starts, wherein the virtual machine 103 runs on the physical machine 102. Then, a first time and a first deadline of the virtual machine 103 which are before the virtual machine 103 starts are determined. Then, in a case where the timer used by the physical machine 102 is a first-type timer 104, adjusting a time of the first-type timer 104 to a second time corresponding to the first time and adjusting a deadline of the first-type timer 104 to a second deadline corresponding to the first deadline to obtain an adjusted first-type timer 105. Finally, the adjusted first-type timer 105 is configured as a timer of the virtual machine 103.

It should be noted that the timer processing method can be executed by the electronic device 101. The electronic device 101 described above may be hardware or software. If the electronic device is hardware, it can be implemented as a distributed cluster composed of multiple servers or terminal devices, or as a single server or a single terminal device. If the electronic device 101 is embodied as software, it may be implemented as multiple pieces of software or multiple software modules for providing distributed services, or may be implemented as a single piece of software or a single software module. Here, no specific limitation is imposed thereto.

It should be understood that the number of the electronic device in FIG. 1 is merely illustrative. There can be any number of electronic devices according to implementation needs.

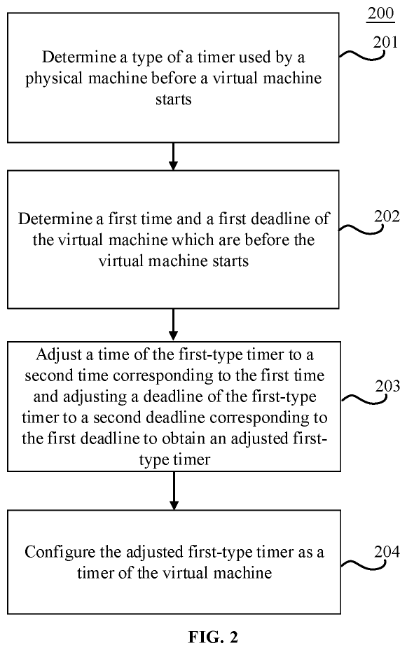

Referring to FIG. 2, a flowchart 200 of a timer processing method according to some embodiments of the present disclosure is shown. The timer processing method comprises the following steps.

In step 201, a type of a timer used by a physical machine before a virtual machine starts is determined.

In some embodiments, the executive body of the timer processing method (such as the electronic device 101 shown in FIG. 1) can determine the type of the timer used by the physical machine before the virtual machine starts through querying, wherein the virtual machine runs on the physical machine. The virtual machine may be a complete computer system with complete hardware system functionality simulated through software and running in a completely isolated environment. Any work that can be done on a physical computer can be done on the virtual machine. When creating the virtual machine on a computer, it is necessary to use a portion of the physical machine's hard disk and memory as the virtual machine's hard disk and memory. Each virtual machine has components such as a hard disk and an operating system that allow users to operate the virtual machine as if it were a physical machine. A physical machine can provide a hardware environment for the virtual machine. Through the cooperation of a physical machine and virtual machines, multiple operating systems (an external operating system and multiple operating systems of the virtual machines) can be installed on the computer, and communication between these operating systems can be achieved as if they were multiple computers. In addition, the physical machine may use at least one timer. As an example, the timer may be a retentive timer or a non-retentive timer.

In step 202, a first time and a first deadline of the virtual machine which are before the virtual machine starts are determined.

In some embodiments, the executive body can determine the first time and first deadline of the virtual machine before the virtual machine starts by querying, wherein the first time and the first deadline of the virtual machine may be in the form of timestamps. As an example, the first time may be: “1492239370”. The first deadline may be “1598339370”.

In step 203, in a case where the timer used by the physical machine is a first-type timer, a time of the first-type timer is adjusted to a second time corresponding to the first time and a deadline of the first-type timer is adjusted to a second deadline corresponding to the first deadline to obtain an adjusted first-type timer.

In some embodiments, in the case where the timer used by the physical machine is the first-type timer, the executive body can adjust the time of the first-type timer to a second time corresponding to the first time, and adjust the deadline of the first-type timer to a second deadline corresponding to the first deadline using time adjustment instructions, so as to obtain an adjusted first-type timer, wherein the first-type timer may be a timer of any specific type. As an example, the first-type timer may be an APIC Timer. The APIC Timer has Periodic Mode, One-Shot Mode, and TSC Deadline Mode. It should be noted that since timers may have different frequencies, before the virtual machine can use the first-type timer normally, it is necessary to adjust the time of the first-type timer to a second time corresponding to the first time and adjust the deadline of the first-type timer to a second deadline corresponding to the first deadline, so that the configured timer can be used by the virtual machine normally.

As an example, the first time may be: “1492239370”. The first deadline may be “1598339370”. After adjustment, the second time may be “1492249370”, and the second deadline may be “1598349370”. That is, the second time may be the same as the first time, and the second deadline may be the same as the first deadline.

In step 204, the adjusted first-type timer is configured as a timer of the virtual machine.

In some embodiments, the executive body can configure the timer of the virtual machine using the adjusted first-type timer in various ways.

In some alternative implementations of some embodiments, in a case where the timer used by the physical machine before the virtual machine starts is a third-type timer, the executive body may not adjust the timer of the physical machine and the deadline of the third-type timer. As an example, the third-type timer may be: a High Precision Event Timer (HPET).

In some alternative implementations of some embodiments, a second time interrupt is triggered to terminate the adjusted first-type timer in response to a detection that a time of the adjusted first-type timer in the virtual machine reaches the second deadline.

It should be noted that in response to the detection that the time of the first-type timer in the virtual machine reaches the deadline of the first-type timer, the physical machine first receives an interrupt request, and then determines whether the interrupt request is used by a virtual machine. If it is used by a virtual machine, a second time interrupt is directly injected to terminate the first-type timer.

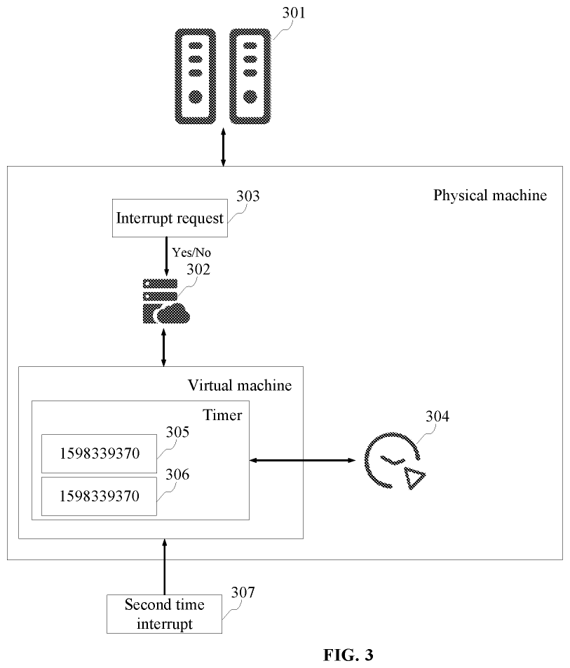

As shown in FIG. 3, in response to a detection that the time 305 of the adjusted first-type timer 304 in the virtual machine 302 reaches a second deadline 306, the physical machine 301 first receives an interrupt request 303, wherein the time 305 and the deadline 306 of the adjusted first-type timer 304 are both “1598339370”. Then, it is determined whether the interrupt request 303 is an interrupt from the virtual machine 302. In response to a determination that the interrupt request 303 is an interrupt from the virtual machine 302, a second time interrupt 307 is directly injected to terminate the adjusted first-type timer 304.

In some alternative implementations of some embodiments, the executive body can instruct the virtual machine to access relevant registers of the adjusted first-type timer.

The above embodiments of the present disclosure have the following beneficial effects. With the timer processing method of some embodiments of this disclosure, the problem of frequent virtual machine exits due to the use of a simulated timer in the virtual machine can be solved in a simple and effective manner, thereby eliminating the impact on virtual machine performance caused by the use of the simulated timer. Particularly, if a virtual machine uses a local APIC timer and runs in TSC-Deadline mode, every time a deadline is set for the timer, the virtual machine exits to the physical machine. In some business scenarios, frequent virtual machine exits have a significant impact on virtual machine performance. In view of this, in the timer processing method of some embodiments of the present disclosure, a type of timer used by a physical machine before a virtual machine starts is first determined, wherein the virtual machine runs on the physical machine. Here, a type of a timer used by a physical machine is determined to enable a virtual machine to use the timer later. In addition, the correlation between the physical machine and the virtual machine is also described. Then, a first time and a first deadline of the virtual machine before the virtual machine starts are determined. Here, a first time and a first deadline are determined for adjusting the timer used by the virtual machine in order to ensure that the timer can be normally used by the virtual machine. Then, in a case where the timer used by the physical machine is a first-type timer, the time of the first-type timer is adjusted to a second time corresponding to the first time, and the deadline of the first-type timer is adjusted to a second deadline corresponding to the first deadline, so as to obtain an adjusted first-type timer. Here, the time frequency of the timer used by the virtual machine previously may be different from that of the first-type timer used by the physical machine. Therefore, it is necessary to adjust the first time and first deadline to match the time and deadline in the first-type timer used by the virtual machine. Finally, though configuring a timer for the virtual machine using the adjusted first-type timer, the problem of frequent virtual machine exits due to the use of a simulated timer in the virtual machine can be solved, thereby eliminating the impact on virtual machine performance caused by the use of the simulated timer.

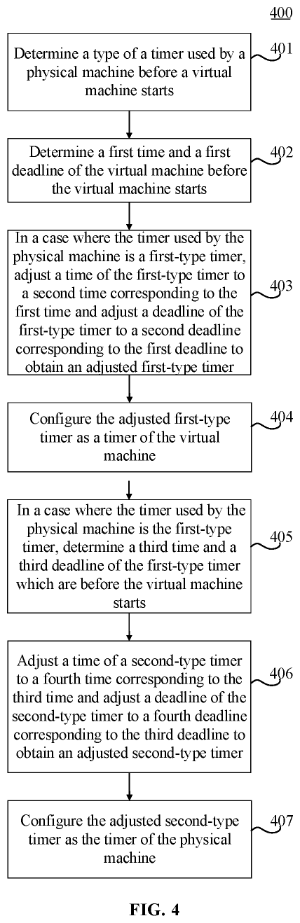

Referring to FIG. 4, a flowchart 400 of a timer processing method according to other embodiments of the present disclosure is shown. The timer processing method comprises the following steps.

In step 401, a type of a timer used by a physical machine before a virtual machine starts is determined, wherein the virtual machine runs on the physical machine.

In step 402, a first time and a first deadline of the virtual machine before the virtual machine starts are determined.

In step 403, in a case where the timer used by the physical machine is a first-type timer, a time of the first-type timer is adjusted to a second time corresponding to the first time and a deadline of the first-type timer is adjusted to a second deadline corresponding to the first deadline to obtain an adjusted first-type timer.

In step 404, the adjusted first-type timer is configured as a timer of the virtual machine.

In some embodiments, for the specific implementation of steps 401-404 and the technical effects brought about, reference may be made to steps 201-204 in the embodiments corresponding to FIG. 2, which will not be described in detail herein.

In step 405, in a case where the timer used by the physical machine is the first-type timer, a third time and a third deadline of the first-type timer which are before the virtual machine starts are determined.

In some embodiments, in a case where the timer used by the physical machine is the first-type timer, the executive body (for example, the electronic device 101 shown in FIG. 1) determines a third time and a third deadline of the first-type timer which are before the virtual machine starts through a query command. The first-type timer may be a APIC Timer. The third time and the third deadline may be a third time and a third deadline used by the physical machine for the first-type timer before the virtual machine starts.

In step 406, a time of a second-type timer is adjusted to a fourth time corresponding to the third time and a deadline of the second-type timer is adjusted to a fourth deadline corresponding to the third deadline to obtain an adjusted second-type timer.

In some embodiments, the executive body may adjust the time of the second-type timer to a fourth time corresponding to the third time, and adjust the deadline of the second-type timer to a fourth deadline corresponding to the third deadline to obtain an adjusted second-type timer, wherein the second-type timer may be a timer different from the first-type timer. As an example, the second type-timer may be a Preemption Timer, wherein the Preemption Timer only starts when the physical machine enters virtual machine mode (i.e. the physical machine enters non root mode).

Similarly, since the second-type timer and the first-type timer may have different frequencies, before the second-type timer can be normally used by the physical machine, it is necessary to adjust the time of the second-type timer to a fourth time corresponding to the third time and adjust the deadline of the second-type timer to a fourth deadline corresponding to the third deadline, so that the configured timer can be normally used by the physical machine.

In step 407, the adjusted second-type timer is configured as the timer of the physical machine.

In some embodiments, the executive body can configure the timer for the physical machine using the adjusted second-type timer.

In the optional implementations of some embodiments, the executive body may further perform the following steps:
Step 1: determining a time difference between the first time and the third time which are before the virtual machine starts;
Step 2, adjusting the fourth time and the fourth deadline according to the time difference. As an example, the executive body can subtract the time difference from both the fourth time and the fourth deadline.

It should be noted that the time on the virtual machine is often smaller than the time on the physical machine. Thus, when the time on the virtual machine reaches the deadline of the adjusted first-type timer, the time on the physical machine is greater than the time on the virtual machine (i.e. the deadline of the adjusted first-type timer). Therefore, according to the implementation principle of the first-type timer, it is impossible to trigger a termination of the adjusted first-type timer. Therefore, the executive body needs to adjust the fourth time and the fourth deadline. So, the virtual machine can use the adjusted first-type timer to trigger a time interrupt.

Optionally, the adjusted second-type timer used by the physical machine is replaced with the first-type timer in response to a detection that the virtual machine exits and the timer used by the physical machine before the virtual machine starts is the first-type timer.

Optionally, a first time interrupt is triggered to terminate the adjusted second-type timer in response to a detection that the time of the adjusted second-type timer in the physical machine reaches the fourth deadline.

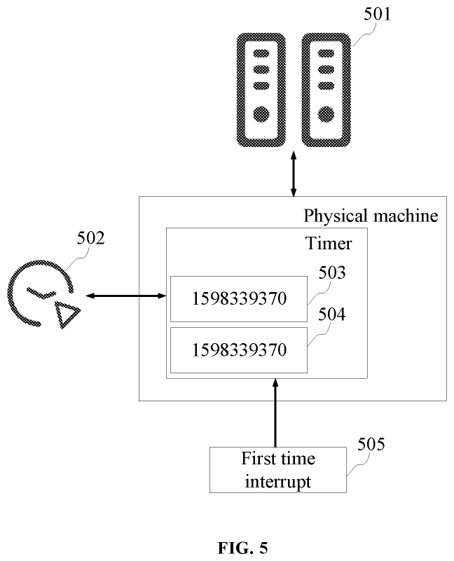

As shown in FIG. 5, in response to a detection that the time 503 of the adjusted second-type timer 502 on the physical machine 501 reaches a fourth deadline 504, a first time interrupt 505 is triggered to terminate the adjusted second-type timer 502, wherein the time 503 of the adjusted second-type timer 502 and the fourth deadline 504 are both: “159339370”.

Optionally, the executive body can add the time of the first-type timer in the physical machine with the time difference to obtain an adjusted time, which is then used as the time of the first-type timer.

It can be seen from FIG. 4 that, compared to the description of some embodiments corresponding to FIG. 2, the process 400 of the timer processing method of the embodiments corresponding to FIG. 4 highlights the specific steps of selecting a timer for the physical machine and adjusting the timer selected for the physical machine after providing a first-type timer to the virtual machine after the virtual machine starts. Therefore, the scheme described in these embodiments can effectively ensure normal timer operation and triggered interrupts for both the timer of the virtual machine and the timer of the physical machine.

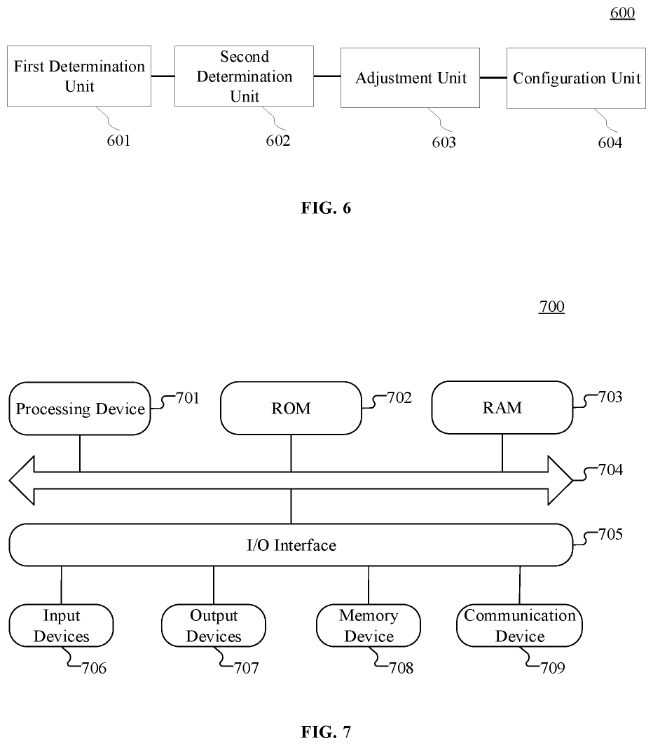

Referring to FIG. 6, as an implementation of the method shown in the above figures, the present disclosure provides some embodiments of a timer processing apparatus. These apparatus embodiments correspond to those method embodiments shown in FIG. 2. Specifically, the apparatus can be applied to various electronic devices.

As shown in FIG. 6, the timer processing apparatus 600 of this embodiment comprises: a first determination unit 601, a second determination unit 602, an adjustment unit 603, and a configuration unit 604. The first determination unit 601 is configured for determining a type of a timer used by a physical machine before a virtual machine starts, wherein the virtual machine runs on the physical machine. The second determination unit 602 is configured for determining a first time and a first deadline of the virtual machine which are before the virtual machine starts. The adjustment unit 603 is configured for, in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer. The configuration unit 604 is configured for configuring the adjusted first-type timer as a timer of the virtual machine.

In the optional implementations of some embodiments, the apparatus 600 may further comprise: a fourth determination unit, a first time adjustment unit, and a timer configuration unit (not shown in the figure). The fourth determination unit may be configured for, in a case where the timer used by the physical machine is the first-type timer, determining a third time and a third deadline of the first-type timer which are before the virtual machine starts. The first time adjustment unit may be configured for adjusting a time of a second-type timer to a fourth time corresponding to the third time and adjusting a deadline of the second-type timer to a fourth deadline corresponding to the third deadline to obtain an adjusted second-type timer. The timer configuration unit is configured for configuring the adjusted second-type timer as the timer of the physical machine.

In the optional implementations of some embodiments, the apparatus 600 may further comprise: a fifth determination unit and a second time adjustment unit (not shown in the figure). The fifth determination unit may be configured for determining a time difference between the first time and the third time which are before the virtual machine starts. The second time adjustment unit is configured for adjusting the fourth time and the fourth deadline according to the time difference.

In the optional implementations of some embodiments, the apparatus 600 may further comprise: a third time adjustment unit (not shown in the figure). The third time adjustment unit may be configured for, in a case where the timer used by the physical machine before the virtual machine starts is a third-type timer, no adjustment is performed on a current time and a deadline of the third-type timer of the physical machine.

In the optional implementations of some embodiments, the apparatus 600 may further comprise: a replacement unit (not shown in the figure). The replacement unit may be configured for: replacing the adjusted second-type timer used by the physical machine with the first-type timer in response to a detection that the virtual machine exits and the timer used by the physical machine before the virtual machine starts is the first-type timer.

In the optional implementations of some embodiments, the apparatus 600 may further comprise: a first termination unit (not shown in the figure). The first termination unit may be configured for: triggering a first time interrupt to terminate the adjusted second-type timer in response to a detection that the time of the adjusted second-type timer in the physical machine reaches the fourth deadline.

In the optional implementations of some embodiments, the apparatus 600 may further comprise: a second termination unit (not shown in the figure). The second termination unit may be configured for: triggering a second time interrupt to terminate the adjusted first-type timer in response to a detection that a time of the adjusted first-type timer in the virtual machine reaches the second deadline.

In the optional implementations of some embodiments, the apparatus 600 may further comprise: an addition unit (not shown in the figure). The addition unit may be configured for: adding the time of the first-type timer in the physical machine with the time difference to obtain an adjusted time as the time of the first-type timer.

In the optional implementations of some embodiments, the apparatus 600 may further comprise: an instruction unit (not shown in the figure). The instruction unit may be configured for: instructing the virtual machine to access relevant register(s) of the adjusted first-type timer.

It can be understood that the units of the apparatus 600 correspond to the various steps in the method described with reference to FIG. 2. Therefore, the operations, features, and beneficial effects described above for the method are also applicable to the apparatus 600 and the units comprised the apparatus 600, which will not be repeated herein.

Referring now to FIG. 7, a structural diagram of an electronic device (e.g., a terminal device shown in FIG. 1) 700 suitable for implementing some embodiments of the present disclosure is shown. The electronic device shown in FIG. 7 is merely an example and should not impose any limitation on the function and scope of the embodiments of the present disclosure.

As shown in FIG. 7, the electronic device 700 may comprise a processing device (e.g., a central processing unit, a graphics processor) 701, which may perform various appropriate actions and processes according to a program stored in Read Only Memory (ROM) 702 or a program loaded from storage device 708 into Random Access Memory (RAM) 703. In RAM 703, various programs and data required for the operation of the electronic device 700 are also stored. Processing device 701, ROM 702 and RAM 703 are connected to each other through bus 704. An input/output (I/O) interface 705 is also connected to the bus 704.

Generally, the following devices can be connected to I/O interface 705: input devices 706 comprising, for example, a touch screen, a touch pad, a keyboard, a mouse, a camera, a microphone, an accelerometer, a gyroscope, etc; output devices 707 comprising a liquid crystal display (LCD), a speaker, a vibrator, etc.; a memory device 708 such as a magnetic tape, a hard disk, etc; and a communication device 709. The communication device 709 enables the electronic device 700 to communicate wirelessly or wirelessly with other devices to exchange data. Although FIG. 7 shows the electronic device 700 with various components, it should be understood that it is not required to implement or have all of these components. Alternatively, more or fewer components can be implemented or provided. Each block shown in FIG. 7 may represent one device, or may represent multiple devices as required.

In particular, according to some embodiments of the present disclosure, the processes described above with reference to the flowcharts may be implemented as computer software programs. For example, some embodiments of the present disclosure comprise a computer program product comprising a computer program carried on a computer-readable medium, the computer program containing program code for performing the method illustrated in the flowcharts. In such embodiments, the computer program may be downloaded and installed from the network through the communication device 709, or installed from the storage device 708, or from the ROM 702. When the computer program is executed by the processing device 701, the above functions defined in the method of some embodiments of the present disclosure are performed. It should be noted that the computer-readable medium described in some embodiments of the present disclosure may be a computer-readable signal medium or a computer-readable storage medium, or any combination thereof. The computer readable storage medium can be, for example, but not limited to, an electronic, magnetic, optical, electromagnetic, infrared, or semiconductor system, apparatus, or device, or any combination of the above. More specific examples of the computer readable storage medium may comprise, but are not limited to: electrical connection with one or more wires, portable computer disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing. In some embodiments of the present disclosure, a computer readable storage medium can be any tangible medium that can contain or store a program, which can be used by or in connection with an instruction execution system, apparatus or device. In some embodiments of the present disclosure, a computer readable signal medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The computer readable signal medium can also be any computer readable medium other than a computer readable storage medium, which can transmit, propagate, or transport a program for use by or in connection with the instruction execution system, apparatus, or device. Program code embodied on a computer readable medium can be transmitted by any suitable medium, comprising but not limited to wire, fiber optic cable, radio frequency (RF), etc., or any suitable combination of the foregoing.

In some embodiments, a client and a server can communicate using any currently known or future developed network protocol such as HyperText Transfer Protocol (HTTP), and can be interconnected by any form or medium of digital data communication, e.g., a communication network. Examples of communication networks comprise a local area network (“LAN”) and a wide area network (“WAN”), the Internet, and end-to-end networks (for example, ad hoc end-to-end networks), as well as any currently known or future developed networks.

The above computer-readable medium may be comprised in the electronic device described above; or it may exist alone without being assembled into the electronic device. The computer-readable medium carries one or more programs that cause, when executed by the electronic device, the electronic device to perform operations of: determining a type of a timer used by a physical machine before a virtual machine starts, wherein the virtual machine runs on the physical machine; determining a first time and a first deadline of the virtual machine which are before the virtual machine starts; in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and configuring the adjusted first-type timer as a timer of the virtual machine.

The computer program code for executing operations of some embodiments of the present disclose may be complied by any combination of one or more program design languages, the program design languages comprising object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, comprising local area network (LAN) or wide area network (WAN), or connected to external computer (for example, through an Internet connection provided by an Internet service provider).

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. It should also be noted that, in some alternative implementations, the functions noted in the block may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Units described in some embodiments of the present disclosure may be implemented in software or in hardware. The described units can also be provided in a processor, which for example can be described as: a processor comprising a first determination unit, a second determination unit, an adjustment unit, and a configuration unit. The name of a unit does not constitute a limitation of the unit itself under certain circumstances, for example, the first determination unit may also be described as “a unit for determining a type of timer used by a physical machine before a virtual machine starts”.

The functions described above may be performed at least in part by one or more hardware logic components. For example, without limitation, exemplary types of hardware logic components that can be used comprise: Field Programmable Gate Array (FPGA), Application Specific Integrated Circuit (ASIC), Application Specific Standard Product (ASSP), System on Chip (SOC), Complex Programmable Logic Device (CPLD), etc.

According to one or more embodiments of the present disclosure, there is provided a timer processing method, comprising: determining a type of a timer used by a physical machine before a virtual machine starts, wherein the virtual machine runs on the physical machine; determining a first time and a first deadline of the virtual machine which are before the virtual machine starts; in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and configuring the adjusted first-type timer as a timer of the virtual machine.

According to one or more embodiments of the present disclosure, the method further comprises: in a case where the timer used by the physical machine is the first-type timer, determining a third time and a third deadline of the first-type timer which are before the virtual machine starts; adjusting a time of a second-type timer to a fourth time corresponding to the third time and adjusting a deadline of the second-type timer to a fourth deadline corresponding to the third deadline to obtain an adjusted second-type timer; and configuring the adjusted second-type timer as the timer of the physical machine.

According to one or more embodiments of the present disclosure, the method further comprises: determining a time difference between the first time and the third time which are before the virtual machine starts; and adjusting the fourth time and the fourth deadline according to the time difference.

According to one or more embodiments of the present disclosure, the method further comprises: in a case where the timer used by the physical machine before the virtual machine starts is a third-type timer, no adjustment is performed on a current time and a deadline of the third-type timer of the physical machine.

According to one or more embodiments of the present disclosure, the method further comprises: replacing the adjusted second-type timer used by the physical machine with the first-type timer in response to a detection that the virtual machine exits and the timer used by the physical machine before the virtual machine starts is the first-type timer.

According to one or more embodiments of the present disclosure, the method further comprises: triggering a first time interrupt to terminate the adjusted second-type timer in response to a detection that the time of the adjusted second-type timer in the physical machine reaches the fourth deadline.

According to one or more embodiments of the present disclosure, the method further comprises: triggering a second time interrupt to terminate the adjusted first-type timer in response to a detection that a time of the adjusted first-type timer in the virtual machine reaches the second deadline.

According to one or more embodiments of the present disclosure, the method further comprises: adding the time of the first-type timer in the physical machine with the time difference to obtain an adjusted time as the time of the first-type timer.

According to one or more embodiments of the present disclosure, configuring a timer for the virtual machine using the adjusted first-type timer comprises: instructing the virtual machine to access relevant register(s) of the adjusted first-type timer.

According to one or more embodiments of the present disclosure, there is provided a timer processing apparatus, comprising: a first determination unit configured for determining a type of a timer used by a physical machine before a virtual machine starts, wherein the virtual machine runs on the physical machine; a second determination unit configured for determining a first time and a first deadline of the virtual machine which are before the virtual machine starts; an adjustment unit configured for, in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; a configuration unit configured for configuring the adjusted first-type timer as a timer of the virtual machine.

According to one or more embodiments of the present disclosure, the apparatus may further comprise: a fourth determination unit, a first time adjustment unit, and a timer configuration unit (not shown in the figure). The fourth determination unit may be configured for, in a case where the timer used by the physical machine is the first-type timer, determining a third time and a third deadline of the first-type timer which are before the virtual machine starts. The first time adjustment unit may be configured for adjusting a time of a second-type timer to a fourth time corresponding to the third time and adjusting a deadline of the second-type timer to a fourth deadline corresponding to the third deadline to obtain an adjusted second-type timer. The timer configuration unit is configured for configuring the adjusted second-type timer as the timer of the physical machine.

According to one or more embodiments of the present disclosure, the apparatus may further comprise: a fifth determination unit and a second time adjustment unit (not shown in the figure). The fifth determination unit may be configured for determining a time difference between the first time and the third time which are before the virtual machine starts. The second time adjustment unit is configured for adjusting the fourth time and the fourth deadline according to the time difference.

According to one or more embodiments of the present disclosure, the apparatus may further comprise: a third time adjustment unit (not shown in the figure). The third time adjustment unit may be configured for, in a case where the timer used by the physical machine before the virtual machine starts is a third-type timer, no adjustment is performed on a current time and a deadline of the third-type timer of the physical machine.

According to one or more embodiments of the present disclosure, the apparatus may further comprise: a replacement unit (not shown in the figure). The replacement unit may be configured for: replacing the adjusted second-type timer used by the physical machine with the first-type timer in response to a detection that the virtual machine exits and the timer used by the physical machine before the virtual machine starts is the first-type timer.

According to one or more embodiments of the present disclosure, the apparatus may further comprise: a first termination unit (not shown in the figure). The first termination unit may be configured for: triggering a first time interrupt to terminate the adjusted second-type timer in response to a detection that the time of the adjusted second-type timer in the physical machine reaches the fourth deadline.

According to one or more embodiments of the present disclosure, the apparatus may further comprise: a second termination unit (not shown in the figure). The second termination unit may be configured for: triggering a second time interrupt to terminate the adjusted first-type timer in response to a detection that a time of the adjusted first-type timer in the virtual machine reaches the second deadline.

According to one or more embodiments of the present disclosure, the apparatus may further comprise: an addition unit (not shown in the figure). The addition unit may be configured for: adding the time of the first-type timer in the physical machine with the time difference to obtain an adjusted time as the time of the first-type timer.

According to one or more embodiments of the present disclosure, the apparatus may further comprise: an instruction unit (not shown in the figure). The instruction unit may be configured for: instructing the virtual machine to access relevant register(s) of the adjusted first-type timer.

According to one or more embodiments of the present disclosure, an electronic device is provided, comprising: one or more processors; a memory device having stored thereon one or more programs that, when executed by the one or more processors, cause the one or more processors to implement the method described in any of the above embodiments.

According to one or more embodiments of the present disclosure, there is provided a non-transitory computer-readable medium having stored thereon a computer program that, when executed by a processor, implements the method described in any of the above embodiments.

The above description only shows preferred embodiments of the present disclosure and illustrates technical principles applied in the present application. Those skilled in the art should understand that the scope of the embodiments of the present disclosure is not limited to the technical solution formed by a specific combination of the above technical features, and should encompass other technical solutions formed by any combinations of the above technical features or their equivalent features without departing from the above inventive concept, such as, a technical solution formed by replacing the above features with technical features with functions similar to those features (but not limited to these features) disclosed in the embodiments of the present disclosure.

1. A timer processing method, comprising:
determining a type of a timer used by a physical machine before a virtual machine starts, wherein the virtual machine runs on the physical machine;
determining a first time and a first deadline of the virtual machine which are before the virtual machine starts;
in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and
configuring the adjusted first-type timer as a timer of the virtual machine.

2. The timer processing method according to claim 1, further comprising:
in a case where the timer used by the physical machine is the first-type timer, determining a third time and a third deadline of the first-type timer which are before the virtual machine starts;
adjusting a time of a second-type timer to a fourth time corresponding to the third time and adjusting a deadline of the second-type timer to a fourth deadline corresponding to the third deadline to obtain an adjusted second-type timer; and
configuring the adjusted second-type timer as the timer of the physical machine.

3. The timer processing method according to claim 2, further comprising:
determining a time difference between the first time and the third time which are before the virtual machine starts; and
adjusting the fourth time and the fourth deadline according to the time difference.

4. The timer processing method according to claim 1, further comprising:
in a case where the timer used by the physical machine before the virtual machine starts is a third-type timer, no adjustment is performed on a current time and a deadline of the third-type timer of the physical machine.

5. The timer processing method according to claim 3, further comprising:
replacing the adjusted second-type timer used by the physical machine with the first-type timer in response to a detection that the virtual machine exits and the timer used by the physical machine before the virtual machine starts is the first-type timer.

6. The timer processing method according to claim 2, further comprising:
triggering a first time interrupt to terminate the adjusted second-type timer in response to a detection that the time of the adjusted second-type timer in the physical machine reaches the fourth deadline.

7. The timer processing method according to claim 1, further comprising:
triggering a second time interrupt to terminate the adjusted first-type timer in response to a detection that a time of the adjusted first-type timer in the virtual machine reaches the second deadline.

8. The timer processing method according to claim 5, further comprising:
adding the time of the first-type timer in the physical machine with the time difference to obtain an adjusted time as the time of the first-type timer.

9. The timer processing method according to claim 1, wherein the configuring the adjusted first-type timer as the timer of the virtual machine comprises:
instructing the virtual machine to access relevant register(s) of the adjusted first-type timer.

10. (canceled)

11. An electronic device, comprising:
one or more processors;
a memory device for storing one or more programs, which when executed by the one or more processors cause the one or more processors to implement a timer processing method comprising:
determining a type of a timer used by a physical machine before a virtual machine starts, wherein the virtual machine runs on the physical machine;
determining a first time and a first deadline of the virtual machine which are before the virtual machine starts;
in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and
configuring the adjusted first-type timer as a timer of the virtual machine.

12. A non-transitory computer-readable storage medium having a computer program stored thereon, wherein the program, when executed by a processor, implements a timer processor method comprising:
determining a type of a timer used by a physical machine before a virtual machine starts, wherein the virtual machine runs on the physical machine;
determining a first time and a first deadline of the virtual machine which are before the virtual machine starts;
in a case where the timer used by the physical machine is a first-type timer, adjusting a time of the first-type timer to a second time corresponding to the first time and adjusting a deadline of the first-type timer to a second deadline corresponding to the first deadline to obtain an adjusted first-type timer; and
configuring the adjusted first-type timer as a timer of the virtual machine.

13. (canceled)

14. (canceled)

15. The electronic device according to claim 11, wherein the processor is configured to:
in a case where the timer used by the physical machine is the first-type timer, determining a third time and a third deadline of the first-type timer which are before the virtual machine starts;
adjusting a time of a second-type timer to a fourth time corresponding to the third time and adjusting a deadline of the second-type timer to a fourth deadline corresponding to the third deadline to obtain an adjusted second-type timer; and
configuring the adjusted second-type timer as the timer of the physical machine.

16. The electronic device according to claim 15, wherein the processor is configured to:
determining a time difference between the first time and the third time which are before the virtual machine starts; and
adjusting the fourth time and the fourth deadline according to the time difference.

17. The electronic device according to claim 11, wherein the processor is configured to:
in a case where the timer used by the physical machine before the virtual machine starts is a third-type timer, no adjustment is performed on a current time and a deadline of the third-type timer of the physical machine.

18. The electronic device according to claim 16, wherein the processor is configured to:
replacing the adjusted second-type timer used by the physical machine with the first-type timer in response to a detection that the virtual machine exits and the timer used by the physical machine before the virtual machine starts is the first-type timer.

19. The electronic device according to claim 15, wherein the processor is configured to:
triggering a first time interrupt to terminate the adjusted second-type timer in response to a detection that the time of the adjusted second-type timer in the physical machine reaches the fourth deadline.

20. The electronic device according to claim 11, wherein the processor is configured to:
triggering a second time interrupt to terminate the adjusted first-type timer in response to a detection that a time of the adjusted first-type timer in the virtual machine reaches the second deadline.

21. The electronic device according to claim 18, wherein the processor is configured to:
adding the time of the first-type timer in the physical machine with the time difference to obtain an adjusted time as the time of the first-type timer.

22. The electronic device according to claim 11, wherein the processor is configured to:
instructing the virtual machine to access relevant register(s) of the adjusted first-type timer.

23. The non-transitory computer-readable storage medium according to claim 12, wherein the program, when executed by a processor, implements a timer processor method comprising:
in a case where the timer used by the physical machine is the first-type timer, determining a third time and a third deadline of the first-type timer which are before the virtual machine starts;
adjusting a time of a second-type timer to a fourth time corresponding to the third time and adjusting a deadline of the second-type timer to a fourth deadline corresponding to the third deadline to obtain an adjusted second-type timer; and
configuring the adjusted second-type timer as the timer of the physical machine.
